(19) United States
(12) Patent Application Publication
(10) Pub. No.: US 2026/0356262 A1
(43) Pub. Date: Nov. 12, 2026

(54) CLIP AND CLIP CONNECTOR

(71) Applicant: YKK Corporation, Tokyo (JP)

(72) Inventor: Yuichi Yamashita, Toyama (JP)

(21) Appl. No.: 19/121,750

(22) PCT Filed: Oct. 18, 2022
(86) PCT No.: PCT/JP2022/038733

§ 371 Date: Apr. 16, 2025

(51) Int. Cl. B60N 2/58; F16B 2/22

(52) U.S. Cl. CPC B60N 2/5825; F16B 2/22

(57) ABSTRACT

A clip includes a sheet portion embedded in a cushion material, and a clip body engageable with a suspender attached to a cover material, and attached to the sheet portion. The clip body includes a base having a bonding surface to the sheet portion, a pair of legs standing from the base and facing each other in a right-left direction, and a pair of claws, the claws respectively provided for the legs and projecting closer to each other in the right-left direction. A dimension in the right-left direction of the sheet portion is larger than a dimension in the right-left direction of the bonding surface of the base, and the dimension in the right-left direction of the bonding surface of the base is smaller than a maximum outer dimension in the right-left direction of the pair of legs.

### TECHNICAL FIELD

The present invention relates to a clip and a clip assembly for attaching a cover material to a cushion material.

### BACKGROUND ART

In conventional seats, chairs, etc., a cushion material is often used, which is installed at a portion such as a seat surface or backrest that comes into contact with a human body and whose surface is covered with a cover material. A cover material attachment is known as a means for attaching the cover material to the cushion material.

For instance, the cover material attachment of Patent Literature 1 is provided with a clip embedded in the cushion material and a suspender attached to the cover material. The cover material can be attached to the cushion material by locking the suspender with the clip.

### CITATION LIST

### Patent Literature(s)

Patent Literature 1: International Publication No. WO 2018/186245

### SUMMARY OF THE INVENTION

### Problem(s) to be Solved by the Invention

In the cover material attachment as described above, however, a pulling force is applied to the clip from the cover material via the suspender, and when the pulling force is excessively large, the clip may be detached from the cushion material. Accordingly, it has been desired to improve a fixing strength of the clip to the cushion material.

An object of the invention is to provide a clip and a clip assembly with an improved fixing strength to the cushion material.

### Means for Solving the Problem(s)

### First Aspect

A clip according to a first aspect of the invention includes: a sheet portion embedded in a cushion material; and a clip body that is engageable with a suspender attached to a cover material, and is attached to the sheet portion, in which the clip body includes a base having a bonding surface bonded to the sheet portion, a pair of legs standing from the base and facing each other in a right-left direction, and a pair of claws, the claws respectively provided for the legs and projecting closer to each other in the right-left direction, a dimension in the right-left direction of the sheet portion is larger than a dimension in the right-left direction of the bonding surface of the base, and the dimension in the right-left direction of the bonding surface of the base is smaller than a maximum outer dimension of outer dimensions in the right-left direction of the clip body determined by the pair of legs.

In this configuration, the pair of claws of the clip body are engageable with the suspender inserted between the pair of legs, and the sheet portion embedded in the cushion material can be adhered to the cushion material. In addition, the dimension in the right-left direction of the bonding surface of the base bonded to the sheet portion, the maximum outer dimension in the right-left direction of the clip body determined by the pair of legs, and the dimension in the right-left direction of the sheet portion are set as described above, which allows the sheet portion to be adhered to the cushion material over a large area around the clip body. In this configuration, the sheet portion is not likely to be released from the cushion material even when a pulling force is applied to the clips via the suspender, and thus the clips are not likely to be detached from the cushion material. Accordingly, it is possible to improve the fixing strength of the clips to the cushion material.

### Second Aspect

In the clip according to the first aspect of the invention, it is preferable that the pair of legs each include a first extension extending in an upward direction from the base, the first extensions extending away from each other in the right-left direction, and a second extension extending in the upward direction from the first extension corresponding thereto to the claw corresponding thereto, and a space into which a part of the cushion material is insertable is formed between the sheet portion and each of the first extensions.

This configuration makes it possible to provide a suitable adhesion area of the sheet portion adhered to the cushion material around the clip body while keeping an insertion space for the suspender between the pair of legs.

### Third Aspect

In the clip according to the first or second aspect of the invention, it is preferable that the dimension in the right-left direction of the sheet portion is two times or more and three times or less as large as the maximum outer dimension of the outer dimensions in the right-left direction of the clip body determined by the pair of legs.

This configuration makes it possible to improve the fixing strength of the clip to the cushion material while keeping the strength of the cushion material.

### Fourth Aspect

In the clip according to any one of the first to third aspects of the invention, the sheet portion is preferably made of non-woven fabric.

This configuration makes it possible to suitably improve the adhesiveness of the sheet portion to the cushion material due to fine holes in the non-woven fabric constituting the sheet portion.

### Fifth Aspect

A clip assembly according to the fifth aspect of the invention includes: a plurality of the clips according to any one of the first to fourth aspects that are arranged along any arrangement direction; and a clip connector connecting the plurality of clips to each other and being elastically deformable.

This configuration has similar effects to those of the clip according to any one of the first to fifth aspects described above. In addition, the clip assembly including the sheet portion for each clip allows the entire shape thereof to follow a shape (e.g., a curved shape) of the groove of the cushion material by elastically deforming the clip connector.

### Sixth Aspect

In the clip assembly according to the fifth aspect of the invention, the sheet portions of the plurality of clips adjacent to each other are preferably arranged at intervals therebetween.

In this configuration, the respective sheet portions of the clips are hard to overlap with each other in various arrangements of the clip assembly, so that the adhesiveness of each clip to the cushion material can be suitably kept.

### BRIEF DESCRIPTION OF DRAWINGS

FIG. 1 is a cross-sectional view illustrating a cover material attachment including a clip according to an exemplary embodiment of the invention.

FIG. 2 is a perspective view illustrating a clip assembly according to the exemplary embodiment.

FIG. 3 is a side view illustrating the clip according to the exemplary embodiment.

FIG. 4 is a perspective view illustrating a state where the clip assembly according to the exemplary embodiment is curved.

FIG. 5 schematically illustrates a state of engaging a suspender with the clip according to the exemplary embodiment.

### DESCRIPTION OF EMBODIMENT(S)

An exemplary embodiment of the invention will be described below with reference to the drawings.

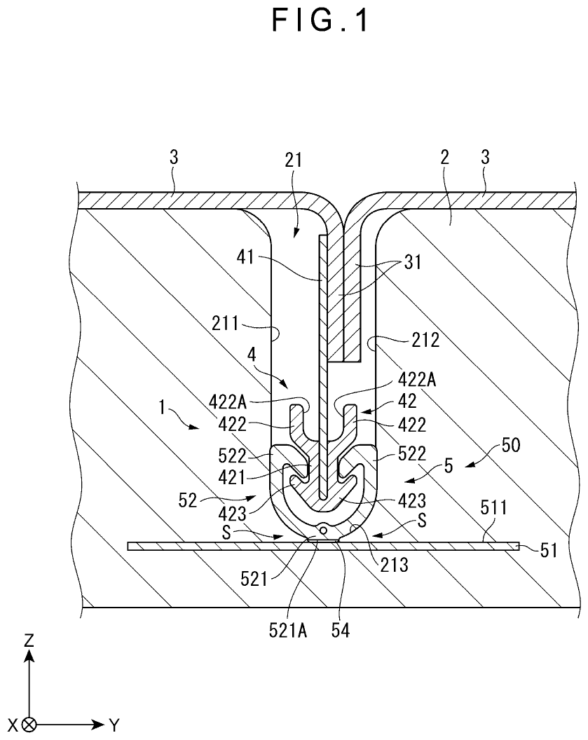

As illustrated in FIG. 1, a cover material attachment I according to the exemplary embodiment is used to attach a cover material 3 to a cushion material 2 of a vehicle seat or the like. The cover material attachment 1 includes a suspender 4 attached to the cover material 3, and a clip assembly 50 installed in a groove 21 of the cushion material 2. The cover material 3 can be attached to the cushion material 2 by locking the suspender 4 with the clip assembly 50.

The cushion material 2 is made of a synthetic resin urethane foam material such as foamed polyurethane that is molded into a seat form. The cushion material 2 is provided with the groove 21 in which clips 5 are installed. The groove 21 defines an opening in a surface of the cushion material 2 and extends along any direction in the surface of the cushion material 2. In the cushion material 2, the groove 21 has a pair of side wall surfaces 211 and 212 facing each other, and a bottom surface 213.

The cover material 3 is a sheet for covering the surface of the cushion material 2 and is, for instance, a synthetic resin fabric sheet. An edge portion 31 of the cover material 3 is attached to the suspender 4 by, for instance, sewing.

A configuration of the cover material attachment I will be described with reference to FIGS. 1 to 3.

In the following description of the configuration of the cover material attachment 1, three axial directions, which are X, Y and Z directions, are used with a state where the suspender 4 is locked with the clip assembly 50 (see FIG. 1) serving as a reference state. For instance, a length direction of the cover material attachment 1 is defined as the X direction, a right-left direction of the cover material attachment 1 is defined as the Y direction, and a top-bottom direction of the cover material attachment 1 is defined as the Z direction. In a state where the cover material 3 is attached to the cushion material 2 through the cover material attachment 1 (see FIG. 1), the X direction corresponds to a length direction of the groove 21 of the cushion material 2, the Y direction corresponds to a width direction of the groove 21, and the Z direction corresponds to a depth direction of the groove 21. It is assumed for the sake of convenience that a direction toward one side (upward) in the Z direction is defined as a +Z direction, a direction toward the other side (downward) in the Z direction is defined as a −Z direction, and the groove 21 is opened in the +Z direction in the cushion material 2.

As illustrated in FIG. 1, the suspender 4 includes an attachment portion 41 to which the edge portion 31 of the cover material 3 is attached, and a suspender body 42 fixed to the attachment portion 41.

In the exemplary embodiment, the attachment portion 41 is a sheet member made of, for instance, non-woven fabric disposed along an XZ plane. For instance, the respective edge portions 31 of the two cover materials 3 are overlaid on the attachment portion 41, and the attachment portion 41 and the edge portions 31 of the cover materials 3 are sewn together.

The suspender body 42 includes a base 421 in which a −Z-side edge of the attachment portion 41 is embedded, a pair of jig projections 422 provided on both sides of the base 421 in the Y direction, and a pair of engagement projections 423 provided on both sides of the base 421 in the Y direction at the-Z side from the pair of jig projections 422.

The pair of jig projections 422 each project outward in the Y direction from the base 421, and form a concave 422A opened in the +Z direction with the base 521. Any jig for operating the suspender 4 is insertable into the concave 422A.

The respective engagement projections 423 project outward in the Y direction from the base 421 at the −Z side from the jig projections 422. The pair of engagement projections 423 forms an anchor shape engageable with the clips 5.

The suspender body 42 in the exemplary embodiment is a resin product that is provided through injection molding with the attachment portion 41 serving as an insert component. Further, the suspender body 42 has a shape continuously or intermittently extending in the X direction so as to be engageable with each clip 5 of the clip assembly 50.

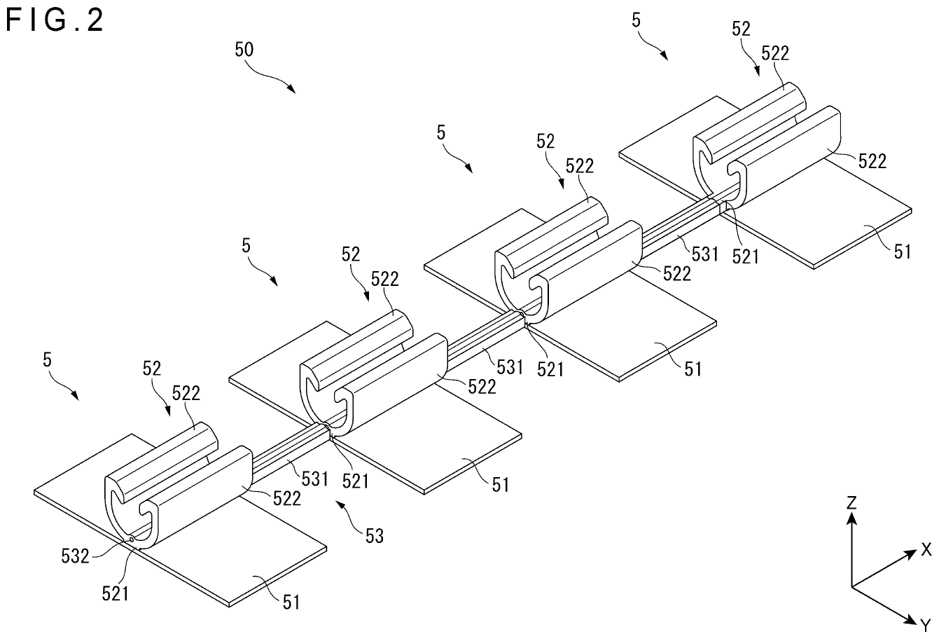

As illustrated in FIG. 2, the clip assembly 50 includes a plurality of clips 5, and a clip connector 53 for connecting the plurality of clips 5 to each other. It should be noted that the following description is based on a state where the plurality of clips 5 are arranged along the X direction. While a configuration of one clip 5 is described as an example in the following description, each of the other clips 5 also has the same configuration.

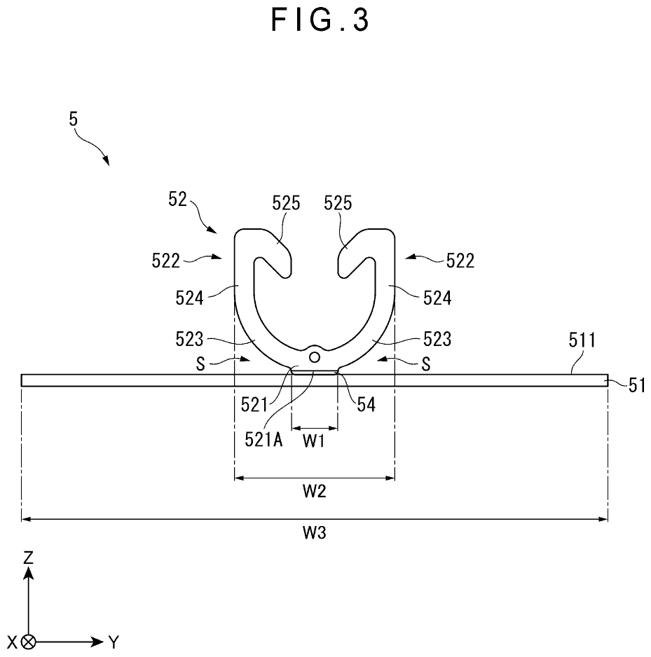

As illustrated in FIG. 1, the clip 5 includes a sheet portion 51 embedded in the cushion material 2, and a clip body 52 engageable with the suspender 4 and attached to the sheet portion 51. The configuration of the clip 5 will be described with reference to FIG. 3.

The sheet portion 51 is a sheet member disposed along an XY plane. A specific material of the sheet portion 51 is not limited but is preferably a non-woven fabric. The sheet portion 51 extends on both sides in the Y direction relative to the clip body 52, and is embedded in the cushion material 2 below the bottom surface 213 of the groove 21 of the cushion material 2 and on both sides in the Y direction of the groove 21. In addition, the sheet portion 51 may have one or more through holes, though illustration thereof is omitted.

The clip body 52 includes a base 521 attached to the sheet portion 51, a pair of legs 522 standing from the base 521 and facing each other in the Y direction, and a pair of claws 525. The claws 525 are respectively provided for the legs 522.

The base 521 is attached to a partial region of a surface 511, facing the +Z side, of the sheet portion 51. Specifically, the base 521 has a bonding surface 521A bonded to the surface 511 of the sheet portion 51. A Y-directional dimension W 3 of the sheet portion 51 is larger than a Y-directional dimension W1 of the bonding surface 521A of the base 521.

A method of bonding the base 521 to the sheet portion 51 is not limited, and any adhesive agent may be used. The bonding surface 521A of the base 521 in the exemplary embodiment is bonded to the sheet portion 51 through a bonding layer 54.

The pair of legs 522 each include a first extension 523 extending in the +Z direction from the base 521 as well as extending outward in the Y direction (i.e., to be away from the other first extension 523 along the Y direction), and a second extension 524 extending in the +Z direction from the corresponding first extension 523 to the corresponding claw 525.

Herein, the first extensions 523 each have a curved shape being curved outwardly in the Y direction while extending in the +Z direction from the base 521. The first extensions 523 face the sheet portion 51, and a space S into which a part of the cushion material 2 is insertable is formed between the sheet portion 51 and each of the first extensions 523. In the exemplary embodiment, a maximum outer dimension W2, of Y-directional outer dimensions of the clip body 52 determined by the pair of legs 522, corresponds to a dimension between respective outer side surfaces of the second extensions 524 of the pair of legs 522 in the Y direction.

The pair of claws 525 project in the −Z direction and inwardly in the Y direction, from tips of the corresponding second extensions 524 of the pair of legs 522. A space into which the suspender 4 is insertable is formed between the pair of claws 525.

In the clip 5 described above, the Y-directional dimension W1 of the bonding surface 521A of the base 521 is smaller than the maximum outer dimension W2 in the Y direction of the clip body 52 determined by the pair of legs 522.

Further, in the clip 5, the Y-directional dimension W3 of the sheet portion 51 is preferably larger than the maximum outer dimension W2 in the Y direction of the clip body 52 determined by the pair of legs 522. Specifically, the Y-directional dimension W3 of the sheet portion 51 is preferably two times or more and three times or less as large as the maximum outer dimension W 2 in the Y direction of the clip body 52 determined by the pair of legs 522.

It should be noted that X-directional dimensions of elements in the clip 5 described above may be set to any dimensions. As illustrated in FIG. 2, it is preferable that the X-directional dimension of the sheet portion 51 is set nearly equal to the X-directional dimension of the clip body 52.

The clip connector 53 is used to connect the plurality of clips 5 arranged in any direction. Specifically, the clip connector 53 includes a plurality of base connecting portions 531 disposed between bases 521 of the clips 5 adjacent to each other, and a linear member 532 continuously penetrating through the plurality of clips 5 and the plurality of base connecting portions 531.

The base connecting portions 531 each have a bar shape extending along the X direction so as to connect the bases 521 of the clips 5 adjacent to each other.

The linear member 532 is, for instance, a metal wire. The plurality of clips 5 and the plurality of base connecting portions 531 may be integrally provided through injection molding with the linear member 532 serving as an insert component.

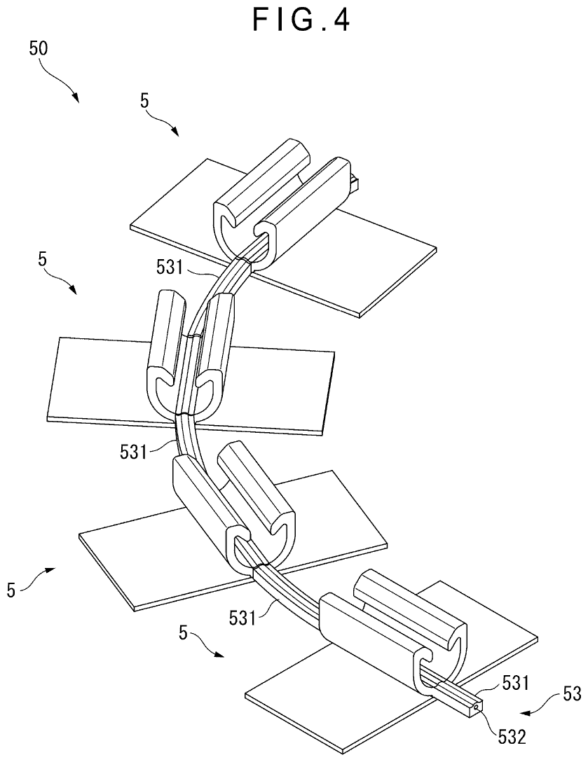

In the clip assembly 50 as described above, the clip connector 53 has some flexibility. For instance, by curving the clip connector 53, the plurality of clips 5 can be arranged along a curved direction, as illustrated in FIG. 4.

### Method of Installing Clip Assembly

An exemplary method of installing the clip assembly 50 of the exemplary embodiment in the cushion material 2 will be briefly described.

First, the clip assembly 50 is set in a trench provided at a mold of the cushion material 2. The trench is a mold for forming the groove 21 of the cushion material 2, and is disposed at a position corresponding to the groove 21.

Next, a material for the cushion material 2 is injected into the mold of the cushion material 2 and then foamed and solidified, so that the cushion material 2 is molded. The material for the cushion material 2 is injected to fill a space around the clip assembly 50 including the spaces S of the clips 5.

The trench and the mold are then removed from the cushion material 2. By the above removal, a region where the trench was positioned in the mold of the cushion material 2 appears as the groove 21. Accordingly, as illustrated in FIG. 1, the clips 5 of the clip assembly 50 are installed in the groove 21.

### Cover Material Attaching Method

A cover material attaching method using the cover material attachment 1 of the exemplary embodiment will be briefly described.

First, a worker prepares the suspender 4 to which the cover material 3 has been attached, and the cushion material 2 in which the clip assembly 50 has been installed in the groove 21, and places the cover material 3 to cover the cushion material 2.

Subsequently, the worker inserts the suspender 4 into the groove 21 of the cushion material 2, and applies pressure in the −Z direction onto the suspender 4 using any pressing means (e.g., a jig or an automatic machine).

For instance, if the worker uses the jig, the pressure in the −Z direction can be applied to the suspender 4 by inserting the jig in the concave 422A defined by one of the jig projections 422 of the suspender 4.

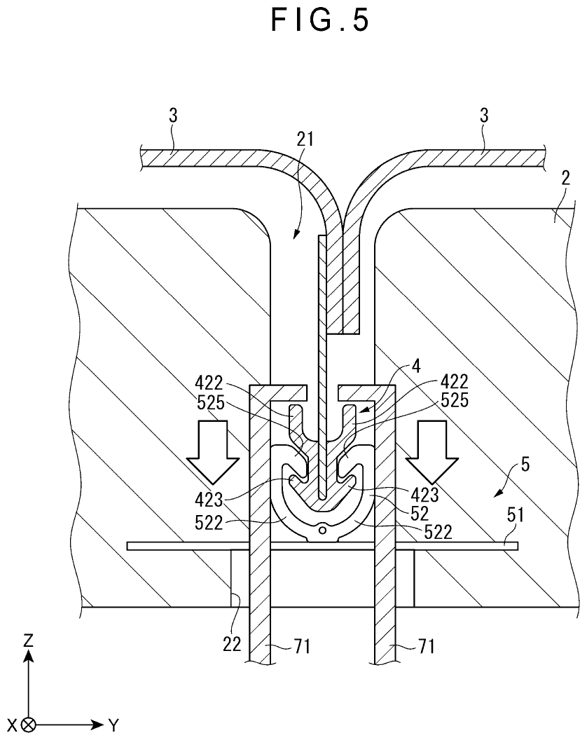

Alternatively, if any automatic machine is used, an operation section 71 of the automatic machine is inserted into a hole 22 formed in a region corresponding to a gap between the clips 5 adjacent to each other, of the bottom surface 213 of the groove 21 of the cushion material 2 (see FIG. 5). The operation section 71 can hold the jig projections 422 of the suspender 4 and apply the pressure in the-Z direction on the suspender 4.

The suspender 4 pressed by any pressing means is pressed against the clip body 52 of each clip 5. Then, the suspender 4 is guided by the pair of claws 525 while elastically deforming the pair of legs 522. When the pair of engagement projections 423 of the suspender 4 pass between the pair of claws 525, the pair of legs 522 are restored to their original shapes, and the pair of engagement projections 423 engage with the pair of claws 525. In this engagement, the pair of claws 525 are each positioned in a space between the jig projection 422 and the engagement projection 423 of the suspender 4.

The suspender 4 is thus locked with the clip 5. This allows the cover material 3 to be attached to the cushion material 2.

### Effects of Exemplary Embodiment

The clip 5 of the exemplary embodiment includes the sheet portion 51 that is embedded in the cushion material 2, and the clip body 52 that is engageable with the suspender 4 attached to the cover material 3 and is attached to the sheet portion 51, as described above. The clip body 52 includes: the base 521 having the bonding surface 521A bonded to the sheet portion 51; the pair of legs 522 standing from the base 521 and facing each other in the right-left direction (Y direction); and the claws 525 respectively provided at the legs 522 and projecting closer to each other in the right-left direction (inwardly in the Y direction). The Y-directional dimension W3 of the sheet portion 51 is larger than the Y-directional dimension W1 of the bonding surface 521A of the base 521, and the Y-directional dimension W1 of the bonding surface 521A of the base 521 is smaller than the maximum outer dimension W2 of the Y-directional outer dimensions of the clip body 52 determined by the pair of legs 522.

In this configuration, the pair of claws 525 of the clip body 52 are engageable with the suspender 4 inserted between the pair of legs 522, so that the sheet portion 51 embedded in the cushion material 2 can be adhered to the cushion material 2. In addition, the Y-directional dimension W1 of the bonding surface 521A of the base 521 bonded to the sheet portion 51, the maximum outer dimension W2 in the Y direction of the clip body 52 determined by the pair of legs 522, and the Y-directional dimension W3 of the sheet portion 51 are set as described above, which allows the sheet portion 51 to be adhered to the cushioning material 2 over a large area around the clip body 52. In this configuration, the sheet portion 51 is not likely to be released from the cushion material 2 even when a pulling force is applied to the clips 5 via the suspender 4, and thus the clips 5 are not likely to be detached from the cushion material 2. Accordingly, it is possible to improve the fixing strength of the clips 5 to the cushion material 2.

In the exemplary embodiment, the adhesion area of the sheet portion 51 to the base 521 is reduced, which allows the sheet portion 51 to be adhered to the cushioning material 2 over a large area around the clip body 52. Here, the bonding strength by a typical adhesive agent is stronger than the adhesion strength by foam resin that constitutes the cushion material 2. Therefore, even when the bonding area of the sheet portion 51 bonded to the base 521 is reduced, the strength of the clip 5 as a whole is hardly affected thereby, and the fixing strength of the clips 5 can be improved without problems.

In the clip 5 of the exemplary embodiment, each leg 522 includes the first extension 523 and the second extension 524. The first extensions 523 of the clip 5 extend upward (in the +Z direction) from the base 521 while extending away from each other in the right-left direction (outward in the Y direction). The second extensions 524 of the clip 5 extend in the +Z direction from the first extensions 523 to the claws 525. The space S into which a part of the cushion material 2 is insertable is formed between the sheet portion 51 and each of the first extensions 523. This configuration makes it possible to provide a suitable adhesion area of the sheet portion 51 adhered to the cushion material 2 around the clip body 52 while keeping an insertion space for the suspender 4 between the pair of legs 522.

In the clip 5 of the exemplary embodiment, the Y-directional dimension W3 of the sheet portion 51 is two times or more and three times or less as large as the maximum outer dimension W2 of the Y-directional outer dimensions of the clip body 52 determined by the pair of legs 522.

In this configuration, the Y-directional dimension W3 of the sheet portion 51 is two times or more as large as the maximum outer dimension W2 in the Y direction of the clip body 52 determined by the pair of legs 522, allowing the sheet portion 51 to have a sufficient adhesion area adhered to the cushion material 2.

In addition, the Y-directional dimension W3 of the sheet portion 51 is three times or less as large as the maximum outer dimension W2 in the Y direction of the clip body 52 determined by the pair of legs 522, thereby ensuring the strength of the cushion material 2.

If the Y-directional dimension W 3 of the sheet portion 51 is more than three times as large as the maximum outer dimension W2 in the Y direction of the clip body 52 determined by the pair of legs 522, the adhesion area of the sheet portion 51 adhered to the cushion material 2 further increases. However, when the cushion material 2 is molded by foaming around the sheet portion 51 having such a dimension, voids (bubbles) are more likely to be generated in the cushion material 2 because a large amount of the material for the cushion material 2 is pulled toward the sheet portion 51. As a result, the strength of the cushion material 2 decreases.

In the exemplary embodiment, the Y-directional dimension W3 of the sheet portion 51 is not simply made large, but while restricting the Y-directional dimension W3 of the sheet portion 51 to three times or less as large as the maximum outer dimension W2 in the Y direction of the clip body 52 determined by the pair of legs 522, the adhesion area of the sheet portion 51 adhered to the cushion material 2 is secured. This makes it possible to improve the fixing strength of the clips 5 to the cushion material 2 while keeping the strength of the cushion material 2.

In the clip 5 of the exemplary embodiment, the sheet portion 51 is made of non-woven fabric. This configuration makes it possible to suitably improve the adhesiveness of the sheet portion 51 to the cushion material 2 due to fine holes in the non-woven fabric constituting the sheet portion 51.

The clip assembly 50 of the exemplary embodiment includes the plurality of clips 5 arranged along any arrangement direction, and the clip connector 53 that connects the plurality of clips 5 to each other and is elastically deformable.

This configuration has similar effects to those of the clip 5 described above. In addition, the clip assembly 50 including the sheet portion 51 for each clip 5 allows the entire shape thereof to follow a shape (e.g., a curved shape) of the groove 21 of the cushion material 2 by elastically deforming the clip connector 53.

In the clip assembly 50 of the exemplary embodiment, the respective sheet portions 51 of the clips 5 adjacent to each other are arranged at intervals therebetween. In this configuration, the respective sheet portions 51 of the clips 5 are hard to overlap with each other in various arrangements of the clip assembly 50, so that the adhesiveness of each clip 5 to the cushion material 2 can be suitably kept.

### Modifications

Although a preferable range of the Y-directional dimension W3 of the sheet portion 51 is described in the above-described exemplary embodiment, the invention is not limited thereto. That is, the Y-directional dimension W3 of the sheet portion 51 may be optionally set in a range larger than the Y-directional dimension W1 of the bonding surface 521A of the base 521.

The sheet portion 51 needs not be made of non-woven fabric but may be any sheet member such as fabric.

In the clip assembly 50 of the above-described exemplary embodiment, each clip 5 includes the sheet portion 51. However, the plurality of clips 5 may share one sheet portion 51.

While the clip assembly 50 in which the plurality of clips 5 are connected to each other is described in the above-described exemplary embodiment, the plurality of clips 5 may be individually separated for use.

Although the clip connector 53 includes the plurality of base connecting portions 531 and the linear member 532 in the above-described exemplary embodiment, the invention is not limited thereto. For instance, the clip connector 53 may include the linear member 532 such as wire without the plurality of base connecting portions 531. Alternatively, the linear member 532 may include the plurality of base connecting portions 531 without the linear member 532. The clip assembly 50 may connect portions other than the bases 521 of the clips S to each other.

In the above-described exemplary embodiment, the first extensions 523 of the legs 522 each have a curved shape. However, the invention is not limited thereto. For instance, the first extensions 523 may each have a liner shape extending outward in the Y direction while extending in the +Z direction from the base 521.

In the above-described exemplary embodiment, the maximum outer dimension W2 in the Y direction of the clip body 52 determined by the pair of legs 522 corresponds to the dimension between the respective outer side surfaces of the second extensions 524 of the pair of legs 522 in the Y direction. However, the invention is not limited thereto. That is, the maximum outer dimension W2 in the Y direction of the clip body 52 determined by the pair of legs 522 may be the maximum dimension of the dimensions between respective outer side surfaces of any portions of the pair of legs 522 in the Y direction.

In the above-described exemplary embodiment, the suspender 4 is not limited to having the configuration described above, and may have any configuration engageable with the clip assembly 50 or the clips 5.

### EXPLANATION OF CODES

1 . . . cover material attachment, 2 . . . cushion material, 21 . . . groove, 211 . . . side wall surface, 212 . . . side wall surface, 213 . . . bottom surface. 22 . . . bole, 3 . . . cover material, 31 . . . edge portion, 4 . . . suspender, 41 . . . attachment portion, 42 . . . suspender body, 421 . . . base, 422 . . . jig projection, 422A . . . concave, 423 . . . engagement projection, 5 . . . clip, 50 . . . clip assembly, 51 . . . sheet portion, 511 . . . surface, 52 . . . clip body, 521 . . . base, 521A . . . bonding surface, 522 . . . leg, 523 . . . first extension, 524 . . . second extension, 525 . . . claw, 53 . . . clip connector, 531 . . . base connecting portion, 532 . . . linear member, 54 . . . bonding layer, 71 . . . operation section, S . . . space.

1. A clip, comprising:
a sheet portion embedded in a cushion material; and
a clip body that is engageable with a suspender attached to a cover material, and is attached to the sheet portion, wherein
the clip body includes a base having a bonding surface bonded to the sheet portion, a pair of legs standing from the base and facing each other in a right-left direction, and a pair of claws, the claws respectively provided for the legs and projecting closer to each other in the right-left direction,
a dimension in the right-left direction of the sheet portion is larger than a dimension in the right-left direction of the bonding surface of the base, and
the dimension in the right-left direction of the bonding surface of the base is smaller than a maximum outer dimension of outer dimensions in the right-left direction of the clip body determined by the pair of legs.

2. The clip according to claim 1, wherein
the pair of legs each include
a first extension extending in an upward direction from the base, the first extensions extending away from each other in the right-left direction, and
a second extension extending in the upward direction from the first extension corresponding thereto to the claw corresponding thereto, and
a space into which a part of the cushion material is insertable is formed between the sheet portion and each of the first extensions.

3. The clip according to claim 1, wherein the dimension in the right-left direction of the sheet portion is two times or more and three times or less as large as the maximum outer dimension of the outer dimensions in the right-left direction of the clip body determined by the pair of legs.

4. The clip according to claim 1, wherein the sheet portion is made of non-woven fabric.

5. A clip assembly, comprising:
a plurality of the clips according to claim 1 that are arranged along any arrangement direction; and
a clip connector connecting the plurality of clips to each other and being elastically deformable.

6. The clip assembly according to claim 5, wherein the sheet portions of the plurality of clips adjacent to each other are arranged at intervals therebetween.
